(19) United States
(12) Patent Application Publication
(10) Pub. No.: US 2022/0368612 A1
(43) Pub. Date: Nov. 17, 2022

(54) ENERGY CONSUMPTION ANALYSIS OF MULTI-OPERATOR COMMUNICATION NETWORK SITE

(71) Applicant: Elisa Oyj, Helsinki (FI)

(72) Inventor: Karri SUNILA, Helsinki (FI)

(73) Assignee: Elisa Oyj, Helsinki (FI)

(21) Appl. No.: 17/767,075

(22) PCT Filed: Oct. 6, 2020
(86) PCT No.: PCT/FI2020/050659

§ 371 Date: Apr. 7, 2022

(30) Foreign Application Priority Data
Oct. 9, 2019 (FI) 20195863

(51) Int. Cl. H04L 43/08; G06F 11/30; H04L 43/16

(52) U.S. Cl. CPC H04L 43/08; G06F 11/3062; H04L 43/16

(57) ABSTRACT

A computer implemented method of energy consumption analysis of a multi-operator communication network site. The method is performed by receiving total energy consumption values of a multi-operator communication network site, wherein the site is divided into two or more individually and independently managed equipment sections, and the total energy consumption covers energy consumption of the whole site, detecting a change of a first magnitude in the total energy consumption at a first point of time, obtaining, from an external source, information about maintenance work taking place in a first section of the site at the first point of time, concluding that the first magnitude represents a first estimate of energy consumption of the first section of the site, and outputting the first estimate of energy consumption.

### TECHNICAL FIELD

The present application generally relates to energy consumption analysis of a multi-operator communication network site.

### BACKGROUND

This section illustrates useful background information without admission of any technique described herein representative of the state of the art.

Communication networks consume significant amount of energy. As data amounts and data speeds increase, the energy consumption increases, too. On the other hand, for environmental reasons, there is a desire to optimize energy consumption. In order to make educated decisions on management of the network there is a need to know energy consumption in different parts of the network.

A simple solution is to use electricity meters to measure consumed energy, but this is not always possible. There may be for example one electricity meter that measures energy that is consumed by a network site that may comprise a plurality individually and independently managed equipment sections. Owner of the site may for example rent one or more equipment sections to other parties. In such case, one operator owns the site and rents equipment space to other operators, whereby the site may comprise a plurality of base stations and other network equipment of different operators. The site may be otherwise divided into separately managed equipment sections, too. Nevertheless, one electricity meter typically measures energy consumption of the whole site. In such case, default energy consumption of the devices in different equipment sections can be used as a basis for estimating energy consumption of respective equipment sections, but such estimates are not accurate and may lead in that changes in energy consumption of individual sections of the site go unnoticed.

Now a new approach is provided for analyzing energy consumption in multi-operator sites.

### SUMMARY

Various aspects of examples of the disclosed embodiments are set out in the claims. Any devices and/or methods in the description and/or drawings which are not covered by the claims are examples useful for understanding the disclosed embodiments.

According to a first example aspect of the present disclosed embodiments, there is provided a computer implemented method of energy consumption analysis of a multi-operator communication network site. The method is performed by
receiving total energy consumption values of a multi-operator communication network site, wherein the site is divided into two or more individually and independently managed equipment sections, and the total energy consumption covers energy consumption of the whole site,
detecting a change of a first magnitude in the total energy consumption at a first point of time,
obtaining, from an external source, information about maintenance work taking place in a first section of the site at the first point of time,
concluding that the first magnitude represents a first estimate of energy consumption of the first section of the site, and
outputting the first estimate of energy consumption.

In an embodiment, the method further comprises comparing the first estimate of energy consumption to a second, earlier estimate set for the first section, and outputting result of said comparison. The result of the comparison can be used for checking whether the first section operates differently than assumed.

In an embodiment, the detected change is temporary decrease of the first magnitude in total power consumption.

In an embodiment, the maintenance work comprises at least one of: changing physical devices, changing settings in physical devices, adding new physical devices.

In an embodiment, receiving total energy consumption values comprises receiving a plurality of values per day for a period of a plurality of days.

In an embodiment, the method further comprises detecting maintenance work taking place in more than one section, and responsively ignoring the detected change of the total energy consumption.

In an embodiment, detecting the change of the first magnitude in the total energy consumption is performed based on comparison of the total energy consumption value at the first point of time to one or more previous total energy consumption values.

In an embodiment, detecting the change of the first magnitude in the total energy consumption comprises ignoring changes whose magnitude is below a threshold.

In an embodiment, detecting the change of the first magnitude in the total energy consumption comprises ignoring changes whose duration is below a threshold.

In an embodiment, detecting the change of the first magnitude in the total energy consumption comprises confirming that the total energy consumption at the first point of time is above 0.

In an embodiment, the method is periodically repeated.

According to a second example aspect of the present disclosure, there is provided an apparatus comprising a processor and a memory including computer program code; the memory and the computer program code configured to, with the processor, cause the apparatus to perform the method of the first aspect or any related embodiment.

According to a third example aspect of the present disclosure, there is provided a computer program comprising computer executable program code which when executed by a processor causes an apparatus to perform the method of the first aspect or any related embodiment.

The computer program of the third aspect may be a computer program product stored on a non-transitory memory medium.

Different non-binding example aspects and embodiments of the present disclosure have been illustrated in the foregoing. The embodiments in the foregoing are used merely to explain selected aspects or steps that may be utilized in implementations of the present disclosure. Some embodiments may be presented only with reference to certain example aspects of the disclosed embodiments. It should be appreciated that corresponding embodiments may apply to other example aspects as well.

### BRIEF DESCRIPTION OF THE DRAWINGS

For a more complete understanding of example embodiments of the present disclosure, reference is now made to the following descriptions taken in connection with the accompanying drawings in which:

FIG. 1 shows an example scenario according to an embodiment;

FIG. 2 shows an apparatus according to an embodiment;

FIG. 3A and 3B show flow diagrams illustrating example methods according to certain embodiments;

FIG. 4 shows a graph of an example of daily total energy consumption; and

FIG. 5 shows graphs of example of hourly total energy consumption values.

### DETAILED DESCRIPTION OF THE DRAWINGS

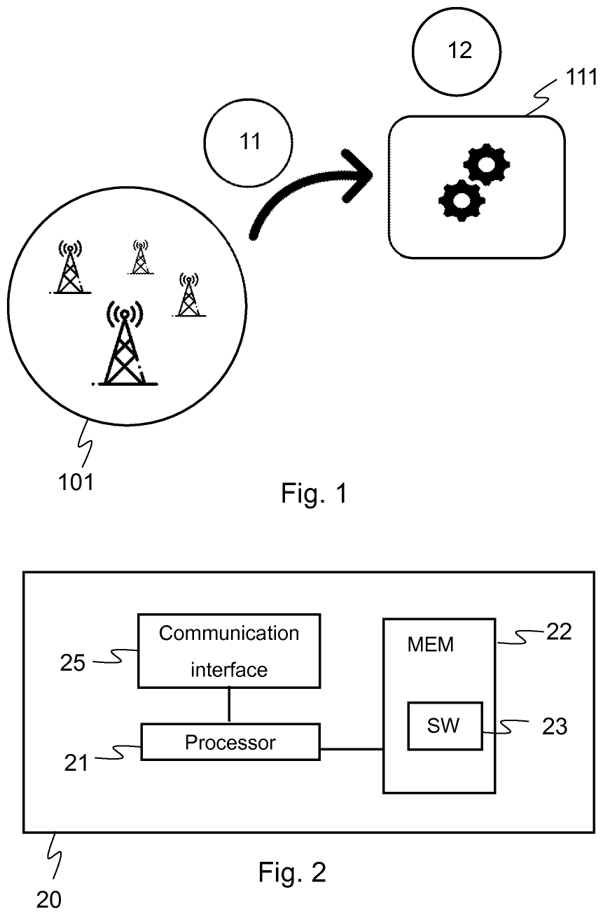

Example embodiments of the present disclosure and its potential advantages are understood by referring to FIGS. 1 through 5 of the drawings. In this document, like reference signs denote like parts or steps.

Example embodiments of the present disclosure provide energy consumption analysis of a multi-operator communication network site based on changes in total consumed energy and knowledge about maintenance work taking place in different equipment sections of the site. The term multi-operator site refers to an entity that comprises a plurality of individually and independently managed equipment sections. The equipment sections may be for example equipment sections of different network operators or otherwise separately managed equipment sections. Example embodiments are suitable in situations where only total energy consumption of a whole site is available and measured energy consumption of the plurality of individually and independently managed equipment sections is not available or the information is not reliable if available.

During maintenance work respective equipment section is in general shut down. Example embodiments are based on using information about the maintenance work to identify which equipment section causes changes in total energy consumption. If an equipment section is shut down, it does not consume energy and based on this the magnitude of the change in total energy consumption is used as an estimate of energy consumption of respective equipment section. When the equipment section is shut down for maintenance work, there is a decrease in total energy consumption, and when the equipment section is turned on after completion of maintenance work or after completion of setup, there is an increase in total energy consumption. The decrease/increase is usually a stepwise change that can be easily identified.

The maintenance work may comprise at least one of: changing physical devices, changing settings in physical devices, adding new physical devices.

FIG. 1 shows an example scenario according to an embodiment. The scenario shows a communication network 101 comprising a plurality of physical network sites comprising base stations and other network devices, and an automation system 111 configured to implement automatic energy consumption analysis according to example embodiments.

In an embodiment of the present disclosure the scenario of FIG. 1 operates as follows: In phase 11, the automation system 111 receives total energy consumption values of a network site. The network site is divided into two or more individually and independently managed equipment sections. The total energy consumption values may be received or collected for example from an electricity meter or from some other system capable of providing the energy consumption values.

In phase 12, the automation system 111 analyses the received total energy consumption values and detects a change in the total energy consumption. The change may be a decrease or an increase in the total consumption values. In an embodiment, one or more checks are being made to ensure that the change is significant before proceeding. E.g. magnitude and/or duration of the change may be checked. Insignificant changes may be ignored.

Responsive to detecting the change in the total energy consumption, the automation system obtains information about maintenance work taking place in the site. If it is detected that there is maintenance work taking place in a first section of the site substantially at the same time with the change in the total energy consumption, it is concluded that magnitude of the change represents a first estimate of energy consumption of the first section. Substantially at the same time herein refers to that the maintenance work take place during duration of the change in the total energy consumption. The information about the maintenance work may be obtained from an external source such as a database storing such information.

The first estimate is then output, and the output may be used as a basis for further actions. The first estimate may be compared to a second estimate and the result of the comparison may be used as a basis for further actions. The second estimate may be assumed energy consumption. Deviation from the assumed energy consumption may be an indication of wrongly operating equipment and therefore the result of the comparison provides the technical effect of ability to identify malfunctioning equipment section or equipment section that does not work as intended.

It is to be noted that analysis of single site is discussed, but multiple sites may be analysed in parallel. The process may be manually or automatically triggered. Additionally or alternatively, the process may be periodically repeated. The process may be repeated for example once a week, every two weeks, once a month, or every two months. By periodically repeating the process, the estimates of energy consumption automatically adapt to changes in the network load and usage patterns.

Energy consumption values may be collected for a plurality of days and/or a plurality of values per day may be collected. For example, hourly values may be collected.

FIG. 2 shows an apparatus 20 according to an embodiment. The apparatus 20 is for example a general-purpose computer or server or some other electronic data processing apparatus. The apparatus 20 can be used for implementing embodiments of the present disclosure. That is, with suitable configuration the apparatus 20 is suited for operating for example as the automation system 111 of foregoing disclosure.

The general structure of the apparatus 20 comprises a processor 21, and a memory 22 coupled to the processor 21. The apparatus 20 further comprises software 23 stored in the memory 22 and operable to be loaded into and executed in the processor 21. The software 23 may comprise one or more software modules and can be in the form of a computer program product. Further, the apparatus 20 comprises a communication interface 25 coupled to the processor 21.

The processor 21 may comprise, e.g., a central processing unit (CPU), a microprocessor, a digital signal processor (DSP), a graphics processing unit, or the like. FIG. 2 shows one processor 21, but the apparatus 20 may comprise a plurality of processors.

The memory 22 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories.

The communication interface 25 may comprise communication modules that implement data transmission to and from the apparatus 20. The communication modules may comprise, e.g., a wireless or a wired interface module. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. Further the apparatus 20 may comprise a user interface (not shown) for providing interaction with a user of the apparatus. The user interface may comprise a display and a keyboard, for example. The user interaction may be implemented through the communication interface 25, too.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like. Further, it is noted that only one apparatus is shown in FIG. 2, but the embodiments of the present disclosure may equally be implemented in a cluster of shown apparatuses.

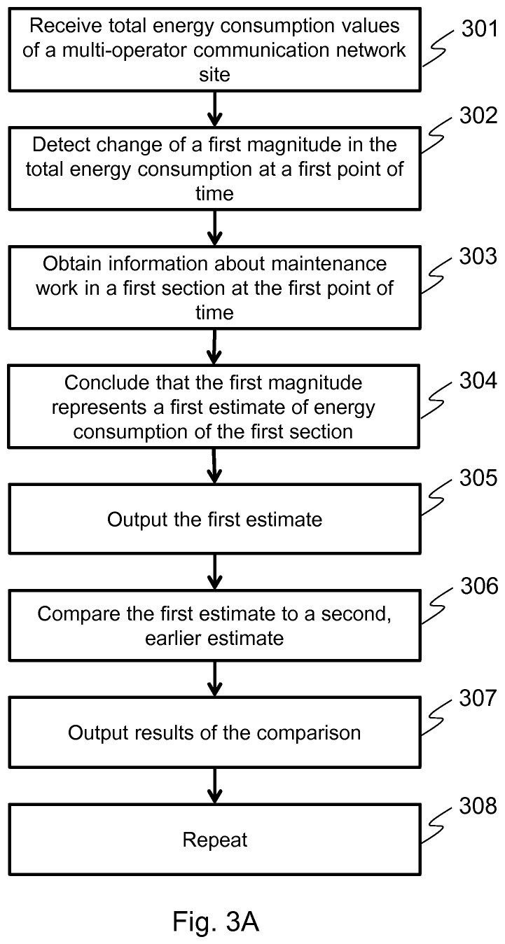

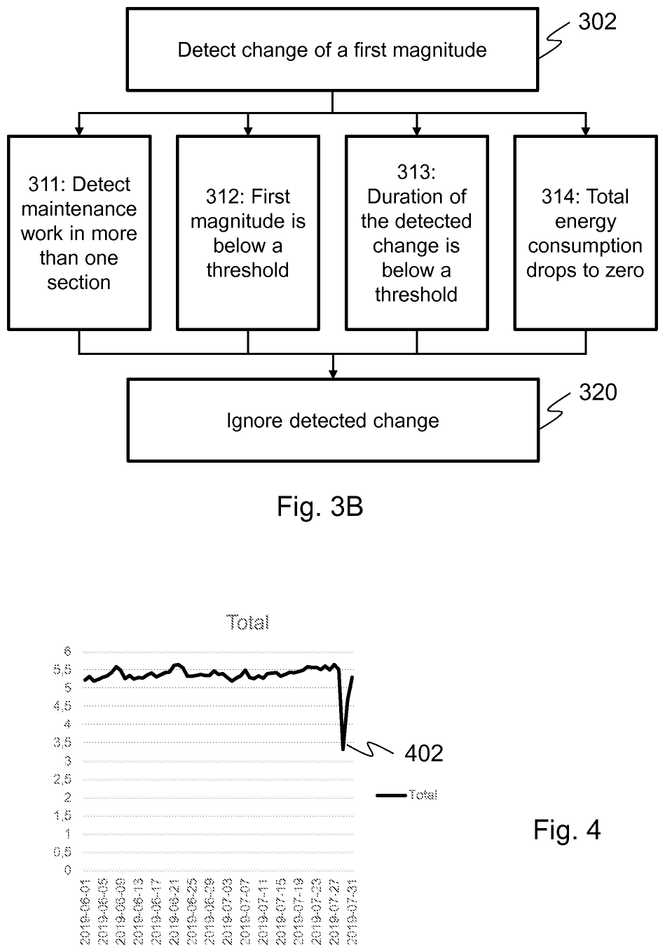

FIG. 3A and 3B show flow diagrams illustrating example methods according to certain embodiments. The methods may be implemented in the automation system 111 of FIG. 1 and/or in the apparatus 20 of FIG. 2. The methods are implemented in a computer and do not require human interaction unless otherwise expressly stated. It is to be noted that the methods may however provide output that may be further processed by humans and/or the methods may require user input to start. Different phases shown in FIG. 3A and 3B may be combined with each other and the order of phases may be changed except where otherwise explicitly defined. Furthermore, it is to be noted that performing all phases of the flow charts is not mandatory.

The method of FIG. 3A comprises following phases:

Phase 301: Total energy consumption values of a multi-operator communication network site are received. The network site is divided into two or more individually and independently managed equipment sections. The total energy consumption values may be received or collected for example from an electricity meter or from some other system capable of providing the energy consumption values.

Phase 302: Analysis of the received total energy consumption values is started and a change of a first magnitude in the total energy consumption is detected at a first point of time. The change may be a decrease or an increase in the total consumption values. The change may be detected based on comparison of the total energy consumption value at the first point of time to one or more previous total energy consumption values.

Phase 303: Information about maintenance work taking place in a first section of the site at the first point of time is obtained from an external source. The external source may be for example an external database. It is to be noted that the change in total energy consumption and the maintenance work do not need to occur at exactly the same time. Instead it suffices that these overlap. If information about maintenance work is not obtained (e.g. there is no maintenance work taking place) the change is ignored, and the process may start from the beginning.

In an embodiment, before proceeding, one or more checks are being made in phases 302 and/or 303 to ensure that the change is significant and/or suitable for making estimates. Such checks are discussed in more detail in connection with FIG. 3B.

Phase 304: It is concluded that the first magnitude represents a first estimate of energy consumption of the first section of the site.

Phase 305: The first estimate of energy consumption is output. The output may be used as a basis for further actions.

Phase 306: In an embodiment, the first estimate is compared to a second, earlier estimate.

Phase 307: The result of the comparison is output. Also this output may be used as a basis for further actions.

The further actions in phases 305 and 307 may comprise for example updating energy consumption estimates, identifying anomalies in energy consumption, adjusting spare power requirements etc. Still further, the first estimate and/or the result of the comparison may be used for identifying equipment sections that operate differently than assumed. For example, malfunctioning equipment sections may be identified.

Phase 308: The process is repeated for example periodically. The process may be repeated for example once a week, every two weeks, once a month, or every two months.

The method of FIG. 3B concerns more detailed example relating to checks associated with detecting the change and a process of selectively ignoring certain changes. The method of FIG. 3B comprises following phases:

Phase 302: A change of a first magnitude in the total energy consumption is detected. Before proceeding to making estimates, additional conditions are checked in phases 311-314 to ensure that the change is significant and/or suitable for making estimates.

Phase 311: It is checked if maintenance work is taking place in more than one section of the site. If this is true, then the detected change is not suitable for making estimates and the process proceeds to phase 320 to ignore the detected change.

Phase 312: It is checked if the first magnitude is below a threshold. If this is true, then the detected change is not significant, and the process proceeds to phase 320 to ignore the detected change. The threshold may be for example 500 W, 700 W or 1 kW or some other selected value. In this way minor changes can be easily ignored.

Phase 313: It is checked if duration of the detected change is below a threshold. If this is true, then the detected change is not significant, and the process proceeds to phase 320 to ignore the detected change. The threshold may be for example one hour. In this way temporary, short-term changes can be easily ignored.

Phase 314: It is checked if the total energy consumption has dropped to zero. If this is true, then the whole site is down (there may be power outage for example) and the detected change is not suitable for making estimates and the process proceeds to phase 320 to ignore the detected change.

Phase 320: If one or more of the checks in phases 311-314 yields true, the detected change is ignored. That is, no further action is taken, and the process may start from the beginning.

FIG. 4 shows a graph of an example of daily total energy consumption. The graph shows total energy consumption for a period between 1 Jun. 2019 and 31 Jul. 2019. The graph shows a dip 402 on 27 Jul. 2019 in the total energy consumption. This dip 402 is a change that can be detected in an analysis according to example embodiments.

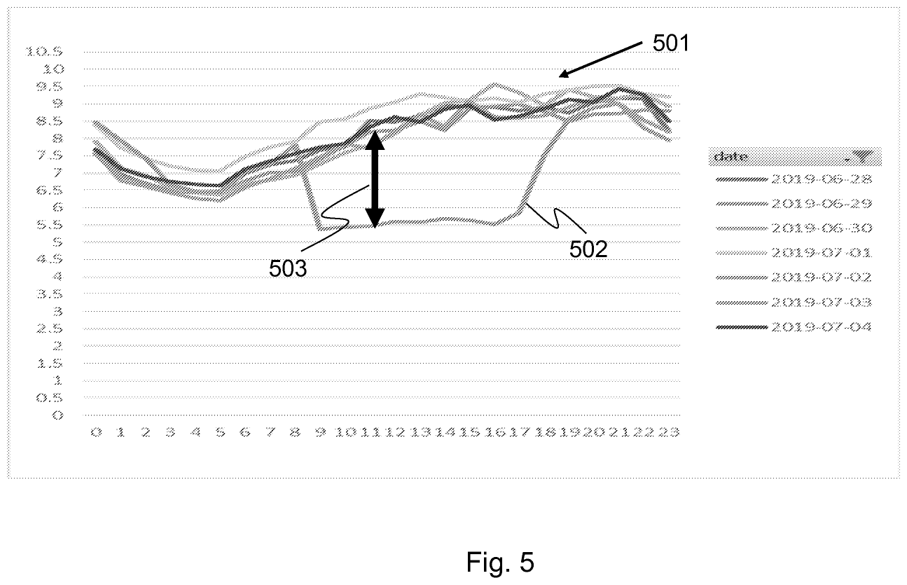

FIG. 5 shows graphs of example of hourly total energy consumption values. The graphs show hourly values 501 for 7 consecutive days between 28 Jun. 2019 and 4 Jul. 2019. The graphs show a dip 502 on 2 Jul. 2019 in the total energy consumption, whereas on the other days the consumption graphs are more or less similar. This dip 502 is a change that can be detected in an analysis according to example embodiments. Arrow 503 illustrates estimated magnitude of the detected change.

Without in any way limiting the scope, interpretation, or application of the claims appearing below, a technical effect of one or more of the example embodiments disclosed herein is ability to obtain improved estimates of the energy consumption of individual sections of a multi-operator site of a communication network. Another technical effect of one or more of the example embodiments disclosed herein is that as the estimates are based on actual energy consumption numbers, the estimate reflects actual spent energy that may vary depending on amount of traffic that flows through the equipment of the section of the site. In this way the estimates take into account changes in energy consumption.

Another technical effect of one or more of the example embodiments disclosed herein is that as a more accurate estimates of the energy consumption of the individual sections of the sites can be obtained, educated decisions on management of the network can be made. For example, equipment that consumes significant amount of energy can be identified and corrective actions to reduce energy consumption can be made. Additionally or alternatively, management of requirements of spare power sources or cooling equipment can be improved as actual energy consumption is being determined.

If desired, the different functions discussed herein may be performed in a different order and/or concurrently with each other. Furthermore, if desired, one or more of the before-described functions may be optional or may be combined.

Although various aspects of the disclosed embodiments are set out in the independent claims, other aspects of the disclosed embodiments comprise other combinations of features from the described embodiments and/or the dependent claims with the features of the independent claims, and not solely the combinations explicitly set out in the claims.

It is also noted herein that while the foregoing describes example embodiments of the present disclosure, these descriptions should not be viewed in a limiting sense. Rather, there are several variations and modifications, which may be made without departing from the scope of the present disclosure as defined in the appended claims.

1. A computer implemented method of energy consumption analysis of a communication network site, the method comprising:
receiving total energy consumption values of the communication network site, wherein the site is divided into two or more equipment sections that are individually and independently managed by different entities, and the total energy consumption covers energy consumption of the whole site, and
finding out a first estimate of the energy consumption of at least one of the equipment sections by:
detecting a change of a first magnitude in the total energy consumption at a first point of time,
obtaining, from an external source, information about maintenance work taking place in a first section of the site at the first point of time, and
outputting the first magnitude as the first estimate of the energy consumption of the first section.

2. The method of claim 1, further comprising comparing the first estimate of energy consumption to a second, earlier estimate set for the first section, and outputting result of said comparison.

3. The method of claim 2, further comprising using the result of the comparison for checking whether the first section operates differently than assumed.

4. The method of claim 1, wherein the detected change is temporary decrease of the first magnitude in total power consumption.

5. The method of claim 1, wherein the maintenance work comprises at least one of: changing physical devices, changing settings in physical devices, adding new physical devices.

6. The method of claim 1, wherein receiving total energy consumption values comprises receiving a plurality of values per day for a period of a plurality of days.

7. The method of claim 1, further comprising detecting maintenance work taking place in more than one section, and responsively ignoring the detected change of the total energy consumption.

8. The method of claim 1, wherein detecting the change of the first magnitude in the total energy consumption is performed based on comparison of the total energy consumption value at the first point of time to one or more previous total energy consumption values.

9. The method of claim 1, wherein detecting the change of the first magnitude in the total energy consumption comprises ignoring changes whose magnitude is below a threshold.

10. The method of claim 1, wherein detecting the change of the first magnitude in the total energy consumption comprises ignoring changes whose duration is below a threshold.

11. The method of claim 1, wherein detecting the change of the first magnitude in the total energy consumption comprises confirming that the total energy consumption at the first point of time is above 0.

12. The method of claim 1, further comprising periodically repeating the method.

13. An apparatus comprising
a processor, and
a memory including computer program code; the memory and the computer program code configured to, with the processor, cause the apparatus to perform energy consumption analysis of a communication network site by
receiving total energy consumption values of the communication network site, wherein the site is divided into two or more equipment sections that are individually and independently managed by different entities, and the total energy consumption covers energy consumption of the whole site, and
finding out a first estimate of the energy consumption of at least one of the equipment sections by
detecting a change of a first magnitude in the total energy consumption at a first point of time,
obtaining, from an external source, information about maintenance work taking place in a first section of the site at the first point of time, and
outputting the first magnitude as the first estimate of the energy consumption of the first section.

14. A non-transitory memory medium comprising computer executable program code which when executed by a processor causes an apparatus to perform energy consumption analysis of a communication network site by
receiving total energy consumption values of the communication network site, wherein the site is divided into two or more equipment sections that are individually and independently managed by different entities, and the total energy consumption covers energy consumption of the whole site, and
finding out a first estimate of the energy consumption of at least one of the equipment sections by
detecting a change of a first magnitude in the total energy consumption at a first point of time,
obtaining, from an external source, information about maintenance work taking place in a first section of the site at the first point of time, and
outputting the first magnitude as the first estimate of the energy consumption of the first section.
